(19) United States
(12) Patent Application Publication
(10) Pub. No.: US 2014/0081873 A1
(43) Pub. Date: Mar. 20, 2014

(54) ONLINE PAYMENT INTERACTIVE PROCESSING METHOD AND ONLINE PAYMENT INTERACTIVE PROCESSING SYSTEM

(71) Applicant: Tencent Technology (Shenzhen) Company Limited, Shenzhen (CN)

(72) Inventors: Dongming XIA, Shenzhen (CN); Jingjian Fan, Shenzhen (CN)

(73) Assignee: Tencent Technology (Shenzhen) Company Limited, Shenzhen (CN)

(21) Appl. No.: 14/063,818

(22) Filed: Oct. 25, 2013

Related U.S. Application Data
(63) Continuation of application No. PCT/CN2013/079128, filed on Jul. 10, 2013.

(30) Foreign Application Priority Data
Jul. 19, 2012 (CN) 201210251023.0

(51) Int. Cl. G06Q 20/40

(52) U.S. Cl. CPC G06Q 20/401
USPC 705/71; 705/39

(57) ABSTRACT

An online payment interactive processing method and system are provided. The method includes: sending a payment request associated with a user account from a client terminal to a payment processing server; receiving a payment completion notification from the payment processing server, the payment completion notification including a unique notification identifier associated with the payment request; sending a payment verification request based on the unique notification identifier to the payment processing server; receiving a payment verification result from the payment processing server; and updating the user account based on information in the payment verification result. According to the present invention, a person with malicious intent who obtains a key associated with the client terminal is prevented from forging a payment completion notification because the person does not have the notification ID, which greatly enhances the security of online payment interactive processing.

### RELATED APPLICATIONS

This application is a continuation application of PCT Patent Application No. PCT/CN2013/079128, entitled “ONLINE PAYMENT INTERACTIVE PROCESSING METHOD AND ONLINE PAYMENT INTERACTIVE PROCESSING SYSTEM” filed on Jul. 10, 2013, which claims priority to Chinese Patent Application No. 201210251023.0, entitled “INTERACTIVE PROCESSING METHOD AND INTERACTIVE PROCESSING SYSTEM,” filed on Jul. 19, 2012, both of which are incorporated by reference in their entirety.

### TECHNICAL FIELD

The disclosed implementations relate generally to the field of interaction security, and in particular, to an online payment interactive processing method and an interactive processing system.

### BACKGROUND

With increasing development of technologies, interaction applications between different computers and different application systems become more and more popular. Take online shopping as an example. Due to characteristics including that one can browse and purchase numerous physical and virtual commodities without going out, applications of network shopping become increasingly popular. In the applications of network shopping, a key step is payment, i.e., online payment. In the current online payment technologies, a merchant website initiates a payment request to a payment platform website, and according to the payment request, the payment platform website provides a related webpage for a user to perform online payment. After the user completes the payment, the payment platform notifies the merchant website of related information of the order and the payment result. After receiving the related information of the order and the payment result, the merchant website verifies the authenticity of the information returned by the payment platform, and after the verification succeeds, the merchant website completes subsequent actions, such as updating state of the order and delivery.

In the current online payment, interaction between the merchant website and the payment platform website is generally based on RSA (an asymmetric cryptographic algorithm) and a message digest algorithm 5 (MD5, used for ensuring completeness and consistency of information transmission). That is, information to be sent is encrypted with the key of a merchant after the MD5 is attached thereto, and then the encrypted information is sent; or information to be sent is encrypted with the key of a merchant before the MD5 is attached thereto, and then the encrypted information is sent. The MD5 is generally computed by connecting the key of the merchant to a parameter string. This is a static computing mode, that is to say, the security of interaction between the merchant website and the payment platform website depends on the security of the key of the merchant. Once the key of the merchant is leaked, a person with malicious intent who obtains the key of the merchant may forge notification information in the name of the payment platform website, which seriously threatens the security of online payment. Likewise, for other types of interactive operation between systems or websites, it is also risky that the interaction security may be affected due to leakage of the key.

### SUMMARY

Accordingly, to solve the security problem in interactive operation, the objective of the present invention is to provide an online payment interactive processing method and an interactive processing system, which may ensure security in interactive processing.

To achieve the above objective, the present invention adopts the following technical solutions.

An online payment interactive processing method includes the steps of:

sending, by a requesting end, processing request information to a processing end, and receiving a notification identifier (ID) that is returned by the processing end according to the processing request information; and

sending, by the requesting end, notification query request information to the processing end according to the notification ID, and receiving a processing result that is corresponding to the notification ID and is returned by the processing end according to the notification query request information.

An online payment interactive processing method includes the steps of:

receiving, by a processing end, processing request information sent by a requesting end, performing processing according to the processing request information, generating a notification ID according to a processing result, and sending the notification ID to the requesting end; and

receiving, by the processing end, notification query request information that is sent by the requesting end according to the notification ID, and sending the processing result corresponding to the notification ID to the requesting end according to the notification query request information.

An interactive processing system includes a requesting end, where

the requesting end is configured to send processing request information to a processing end, receive a notification ID that is returned by the processing end according to the processing request information, send notification query request information to the processing end according to the notification ID, and receive a processing result that is corresponding to the notification ID and is returned by the processing end according to the notification query request information.

An interactive processing system includes a processing end, where

the processing end is configured to receive processing request information sent by a requesting end, perform processing according to the processing request information, generate a notification ID according to a processing result, send the notification ID to the requesting end, receive notification query request information that is sent by the requesting end according to the notification ID, and send the processing result corresponding to the notification ID to the requesting end according to the notification query request information.

A method of online payment performed at a terminal having a processor and memory for storing one or more programs to be executed by the processor comprises: at a client terminal having one or more processors and memory; sending a payment request to a server, receiving a payment completion notification from the server; sending a payment verification request to the server; and receiving a payment verification result from the server and updating account based on the information in the payment verification result.

An method of online payment performed at a terminal having a processor and memory for storing one or more programs to be executed by the processor comprises: at a server having one or more processors and memory; receiving a payment request; generating and sending a payment completion notification to a client terminal; receiving a payment verification request from the client terminal; and generating and sending a payment verification result to the client terminal.

A server of processing online payment, comprises: one or more processors; memory; and one or more programs stored in the memory and to be executed by the processor, wherein the one or more programs include instructions for: receiving a payment request, generating and sending a payment completion notification to a client terminal, receiving a payment verification request from the client terminal with a key that is randomly generated by the client terminal, generating and sending a payment verification result to the client terminal, wherein the payment verification result is encrypted by the key.

A server of processing online payment, comprises: one or more processors; memory; and one or more programs stored in the memory and to be executed by the processor, the one or more programs including instructions for: receiving a payment request for a transaction from a client terminal; judging whether the transaction meets certain predetermined criteria; if the transaction does not meet the certain predetermined criteria, generating and sending a payment completion notification to a client terminal, receiving a payment verification request from the client terminal with a key that is randomly generated by the client terminal; generating and sending a payment verification result to the client terminal, wherein the payment verification result is encrypted by the key; and if the transaction meets the certain predetermined criteria, generating and sending a payment completion result to the client terminal.

In accordance with some embodiments, a method of online payment is performed at a client terminal having a processor and memory for storing one or more programs to be executed by the processor, the method comprising: sending a payment request associated with a user account to a payment processing server; receiving a payment completion notification from the payment processing server, the payment completion notification including a unique notification identifier associated with the payment request; sending a payment verification request based on the unique notification identifier to the payment processing server; receiving a payment verification result from the payment processing server; and updating the user account based on information in the payment verification result.

In accordance with some embodiments, a method of online payment is performed at a payment processing server having a processor and memory for storing one or more programs to be executed by the processor, the method comprising: receiving a payment request from a client terminal, wherein the payment request is generated in response to a transaction request from a terminal associated with a user account; generating and sending a payment completion notification to the client terminal, the payment completion notification including a unique notification identifier associated with the payment request; receiving a payment verification request from the client terminal; verifying the payment verification request using the unique notification identifier; and generating and sending a payment verification result to the client terminal.

In accordance with some embodiments, a server of processing online payment includes: one or more processors; memory; and one or more programs stored in the memory and to be executed by the processor, the one or more programs including instructions for: receiving a payment request from a client terminal, wherein the payment request is generated in response to a transaction request from a terminal associated with a user account; generating and sending a payment completion notification to the client terminal, the payment completion notification including a unique notification identifier associated with the payment request; receiving a payment verification request from the client terminal; verifying the payment verification request using the unique notification identifier; and generating and sending a payment verification result to the client terminal.

According to the solution of the present invention, the requesting end sends the processing request information to the processing end, the processing end performs processing according to the processing request information and returns the notification ID based on the processing request information to the requesting end, and the requesting end further obtains the processing result corresponding to the notification ID from the processing end according to the notification ID. The requesting end generally saves information such as a domain name or an address of the processing end and sends information to the processing end based on the saved information such as the domain name or the address of the processing end, and it is difficult for another person to modify the information saved by the requesting end, such as the domain name or the address of the processing end. Based on the solution, a person with malicious intent who obtains a key of the requesting end is prevented from pretending to be the processing end or receiving the notification query request information from the requesting end, and thus cannot forge a processing result corresponding to the notification ID, which greatly enhances the security of interactive processing.

### BRIEF DESCRIPTION OF DRAWINGS

The aforementioned implementation of the invention as well as additional implementations will be more clearly understood as a result of the following detailed description of the various aspects of the invention when taken in conjunction with the drawings. Like reference numerals refer to corresponding parts throughout the several views of the drawings.

FIG. 1 is a schematic flow chart of Embodiment 1 of an online payment interactive processing method of the present invention;

FIG. 2 is a schematic flow chart of Embodiment 2 of an online payment interactive processing method of the present invention;

FIG. 3 is a schematic flow chart of Embodiment 3 of an online payment interactive processing method of the present invention;

FIG. 4 is a schematic diagram of interaction in a specific example where a requesting end is a merchant website and a processing end is a payment platform website;

FIG. 5 is a schematic flow chart of Embodiment 4 of an online payment interactive processing method of the present invention;

FIG. 6 is a schematic flow chart of an embodiment of an online payment method of the present invention;

FIG. 7 is a schematic flow chart of an embodiment of an online payment method of the present invention; and

FIG. 8 is a schematic structural diagram of an embodiment of an interactive processing system of the present invention.

### DETAILED DESCRIPTION

The solutions of the present invention are illustrated in detail below with reference to exemplary embodiments thereof. In the following description, embodiments of an online payment interactive processing method of the present invention are illustrated before embodiments of an interactive processing system of the present invention. All interactive processing methods/systems in the embodiment of this invention can be applied to online payment methods/systems. When an interactive processing method/system is applied to online payment, the processing end can be a server that supports an online payment platform or a bank and the requesting end can be a client terminal of the server and interacts with a merchant website.

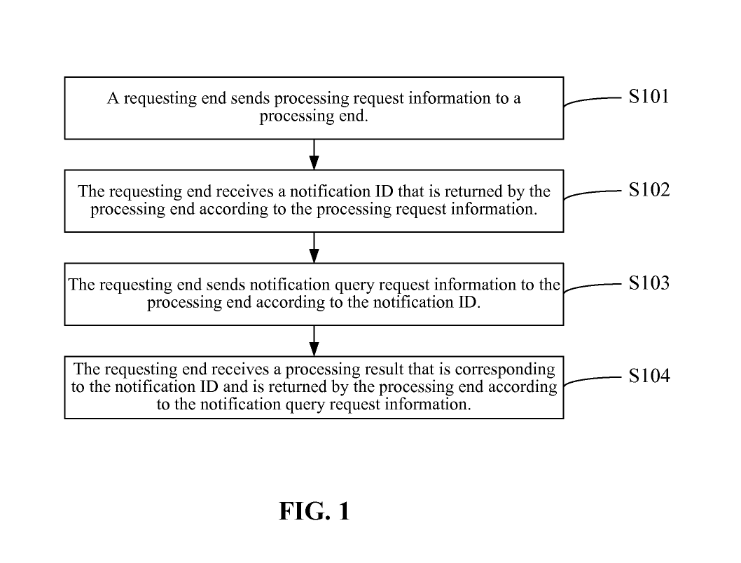

FIG. 1 is a schematic flow chart of Embodiment 1 of an online payment interactive processing method of the present invention. In Embodiment 1, a processing procedure of a requesting end is taken as an example for illustration.

As shown in FIG. 1, the online payment interactive processing method in Embodiment 1 includes the following steps.

Step S101: A requesting end sends processing request information to a processing end.

Step S102: The requesting end receives a notification identifier (ID), which is a payment completion notification, returned by the processing end according to the processing request information.

Step S103: The requesting end sends notification query request information (a payment verification request for the notified payment) to the processing end according to the notification ID.

Step S104: The requesting end receives a processing result (payment verification result) that is corresponding to the notification ID and is returned by the processing end according to the notification query request information.

According to the solution in this embodiment, the requesting end sends the processing request information to the processing end, the processing end performs processing according to the processing request information and returns the notification ID based on the processing request information to the requesting end, and the requesting end further obtains the processing result corresponding to the notification ID from the processing end according to the notification ID. The requesting end generally saves information such as a domain name or an address of the processing end and sends information to the processing end based on the saved information such as the domain name or the address of the processing end, and it is difficult for another person to modify the information saved by the requesting end, such as the domain name or the address of the processing end. Based on the solution, a person with malicious intent who obtains a key of the requesting end is prevented from pretending to be the processing end or receiving the notification query request information from the requesting end, and thus cannot forge a processing result corresponding to the notification ID, which greatly enhances the security of interactive processing.

When returning the notification ID to the requesting end according to the processing request information, the processing end may also return the processing result of implementation based on the processing request information, that is, the requesting end also receives the processing result that is returned by the processing end according to the processing request information.

Therefore, in addition to the notification ID, the requesting end also receives the processing result for the processing request information. In this way, the requesting end may determine, according to requirements, whether to send the notification query request information to the processing end and obtain the processing result again to perform further verification or confirmation. The specific implementation may be related to configuration of the requesting end or requirements of an operator of the requesting end. When the notification query request information needs to be sent, a notification query instruction may be issued, and after receiving the notification query instruction, the requesting end sends the notification query request information to the processing end. Whether a notification query request needs to be sent may be determined according to actual requirements and in various possible manners, and it may also be set that notification query request information needs to be sent for any received notification ID.

In a specific example, the requesting end may be a merchant website or a computer that interacts with the merchant website, and correspondingly, the processing end may be a payment platform website or a server computer interacts with the payment platform website. For the merchant website, a paying action of an order is required to be processed by the payment platform website or the bank website. Therefore, after receiving a processing result corresponding to the notification ID and returned by the payment platform website or the bank website, the merchant website may also update state of the order according to the processing result.

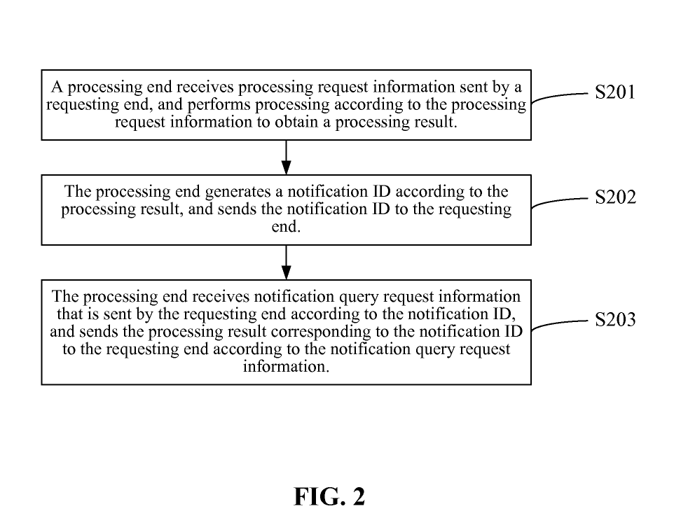

FIG. 2 is a schematic flow chart of Embodiment 2 of an online payment interactive processing method of the present invention. In Embodiment 2, a processing procedure of a processing end is taken as an example for illustration.

As shown in FIG. 2, the online payment interactive processing method in Embodiment 2 includes the following steps.

Step S201: A processing end receives processing request information sent by a requesting end, and performs processing according to the processing request information to obtain a processing result.

Step S202: The processing end generates a notification ID according to the processing result, and sends the notification ID to the requesting end.

Step S203: The processing end receives notification query request information that is sent by the requesting end according to the notification ID, and sends the processing result corresponding to the notification ID to the requesting end according to the notification query request information.

According to the solution in this embodiment, the processing end receives the processing request information, performs processing according to the processing request information to obtain the processing result, returns the notification ID based on the processing request information to the requesting end, and after receiving the notification query request information that is sent by the requesting end according to the notification ID, sends the processing result corresponding to the notification ID to the requesting end. The requesting end generally saves information such as a domain name or an address of the processing end and sends information to the processing end based on the saved information such as the domain name or the address of the processing end, and it is difficult for another person to modify the information saved by the requesting end, such as the domain name or the address of the processing end. Based on the solution, a person with malicious intent who obtains a key of the requesting end is prevented from pretending to be the processing end or receiving the notification query request information from the requesting end, and thus cannot forge a processing result corresponding to the notification ID, which greatly enhances the security of interactive processing.

In a processing manner, when returning the notification ID to the requesting end according to the processing request information, the processing end may also return the processing result of implementation based on the processing request information, and the requesting end decides whether to obtain the processing result corresponding to the notification ID again to verify the security of the obtained processing result.

In a specific example, the requesting end may be a merchant website, and correspondingly, the processing end may be a payment platform website or a bank website. For the merchant website, a paying action of an order is required to be processed by the payment platform website or the bank website. Therefore, after receiving a processing result corresponding to the notification ID and returned by the payment platform website or the bank website, the merchant website may also update state of the order according to the processing result.

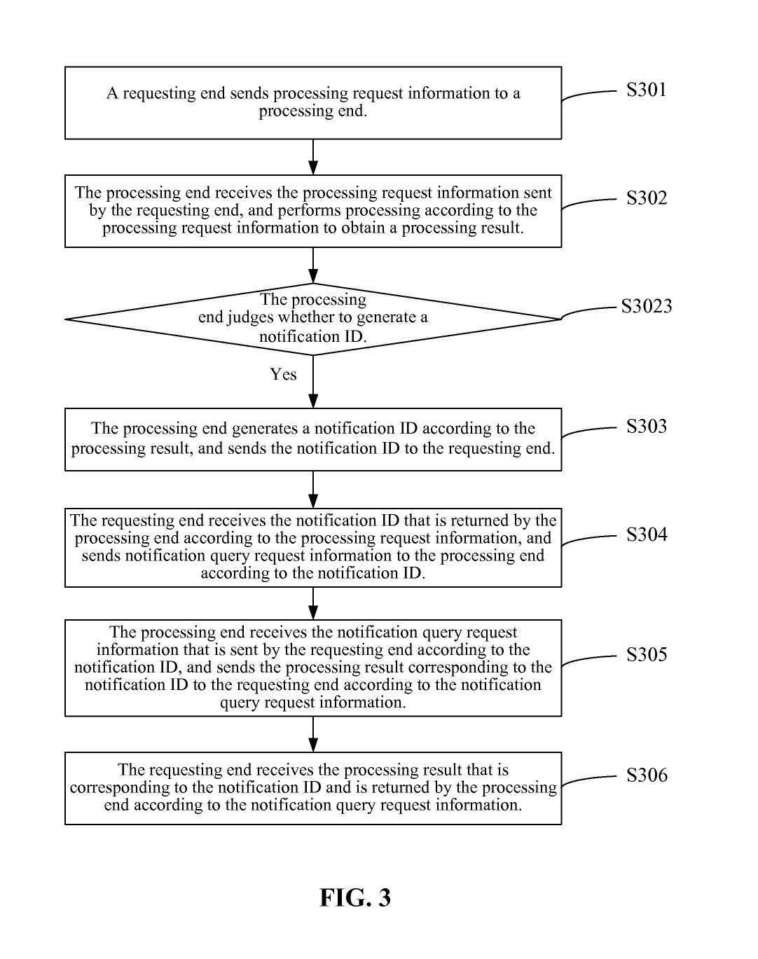

FIG. 3 is a schematic flow chart of Embodiment 3 of an online payment interactive processing method of the present invention. In Embodiment 3, an interaction process between a requesting end and a processing end is taken as an example for illustration, in which the processing end always only returns a notification ID after receiving processing request information.

As shown in FIG. 3, the online payment interactive processing method in Embodiment 3 includes the following steps.

Step S301: A requesting end sends processing request information to a processing end.

Step S302: The processing end receives the processing request information sent by the requesting end, and performs processing according to the processing request information to obtain a processing result.

Step S303: The processing end generates a notification ID according to the processing result, and sends the notification ID to the requesting end.

Step S304: The requesting end receives the notification ID that is returned by the processing end according to the processing request information, and sends notification query request information to the processing end according to the notification ID.

Step S305: The processing end receives the notification query request information that is sent by the requesting end according to the notification ID, and sends the processing result corresponding to the notification ID to the requesting end according to the notification query request information.

Step S306: The requesting end receives the processing result that is corresponding to the notification ID and is returned by the processing end according to the notification query request information.

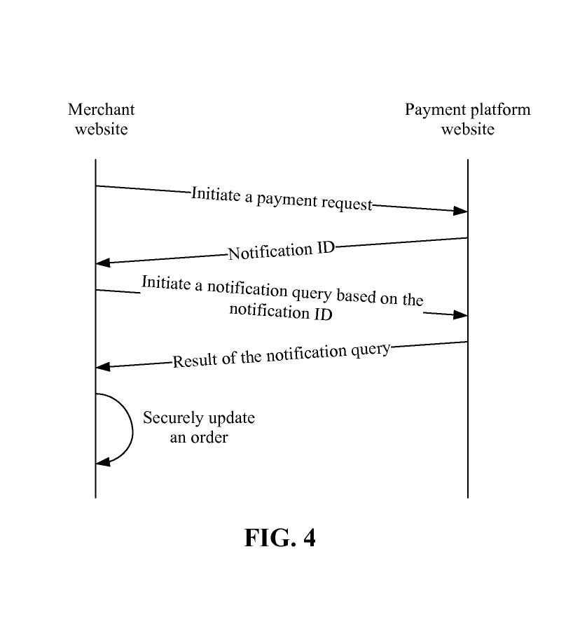

FIG. 4 is a schematic diagram of a paying process in a specific example, where the requesting end is a merchant website and the processing end is a payment platform website.

Based on the online payment interactive processing method in Embodiment 3, the paying process shown in FIG. 4 may be described as follows.

After a user completes related order information and determines to pay for an order, the merchant website initiates a payment request to the corresponding payment platform website, that is, sends the processing request information to the payment platform website.

After receiving the payment request sent by the merchant website, the payment platform website completes payment of the order, and the payment of the order may be implemented in any possible manner. After the payment is completed, the payment platform website generates a notification ID of the order and identifies the order and the payment status related to the order, and after generating the notification ID, the payment platform website sends the notification ID to the merchant website.

After receiving the notification ID returned by the payment platform website, the merchant website sends notification query request information to the payment platform website according to the notification ID, where the notification query request information includes the notification ID.

After receiving the notification query request information sent by the merchant website, the payment platform website queries for a corresponding processing result according to the notification ID in the notification query request information. The processing result may include order information and processing result information related to the order. Definitely, the processing result may also be configured according to actual requirements, for example, the processing result may only include an order number, information about whether the payment is successful, and the like.

After receiving the processing result returned by the merchant website, the merchant website updates state of the order according to the processing result, and accordingly completes subsequent actions, such as a prompt of delivery of a virtual commodity or a physical commodity.

In the description of Embodiment 3 of the online payment interactive processing method in the present invention, it is taken as an example that the processing end only sends the notification ID to the requesting end and the requesting end always needs to query for the processing result from the processing end according to the notification ID. In another implementation manner, it is also applicable that the processing end judges whether to generate a notification ID and send the notification ID to the requesting end. That is, the following step may be performed between Step S302 and Step S303.

S3023: The processing end judges whether to generate a notification ID, and if yes, proceed to Step S303.

That is to say, the processing end judges whether to generate a notification ID. When it is determined that a notification ID needs to be generated, the processing end performs subsequent processes such as generating the notification ID; and when it is determined that a notification ID does not need to be generated, the processing end may directly send the processing result to the requesting end.

The processing end may judge whether to generate a notification ID in various possible manners, for example, according to the type of the processing request information, the type and performance of the requesting end, and the like. It may even be set that a notification ID needs to be generated for any processing request information, and a specific manner of judging whether a notification ID needs to be generated is not described herein.

In this case, taking the paying process in FIG. 4 as an example, a specific processing procedure may be described as follows.

After a user completes related order information and determines to pay for an order, the merchant website initiates a payment request to the corresponding payment platform website, that is, sends the processing request information to the payment platform website.

After receiving the payment request sent by the merchant website, the payment platform website completes payment of the order, and the payment of the order may be implemented in any possible manner.

After completing the payment, the payment platform website judges whether a notification ID of the order needs to be generated, and a specific judging condition may be set according to requirements. For the payment platform website, whether a notification ID needs to be generated may be judged according to factors, such as the type and scale of the merchant website and the nature of the commodity in the order. For example, it may be set in the payment platform website that a notification ID needs to be generated according to a payment request of a specific merchant website, or a notification ID needs to be generated according to a payment request of a merchant website when the scale of the merchant website is smaller than a preset threshold, or a notification ID needs to be generated according to a payment request when the commodity in the order is a virtual commodity; or the payment platform website judges whether a notification ID needs to be generated by taking into account the type and scale of the merchant website, the nature of the commodity in the order, and other related factors. Definitely, according to actual requirements, any other possible manner may also be adopted to judge whether a notification ID needs to be generated, and a specific judging manner is not described herein.

When it is determined that a notification ID needs to be generated, the payment platform website generates a notification ID of the order, to identify the order and the payment status related to the order, and after generating the notification ID, the payment platform website sends the notification ID to the merchant website.

After receiving the notification ID returned by the payment platform website, the merchant website sends notification query request information to the payment platform website according to the notification ID, where the notification query request information includes the notification ID.

After receiving the notification query request information sent by the merchant website, the payment platform website queries for a corresponding processing result according to the notification ID in the notification query request information. The processing result may include order information and processing result information related to the order. Definitely, the processing result may also be configured according to actual requirements, for example, the processing result may only include an order number, information about whether the payment is successful, and the like.

After receiving the processing result returned by the merchant website, the merchant website updates state of the order according to the processing result, and accordingly completes subsequent actions, such as a prompt of delivery of a virtual commodity or a physical commodity.

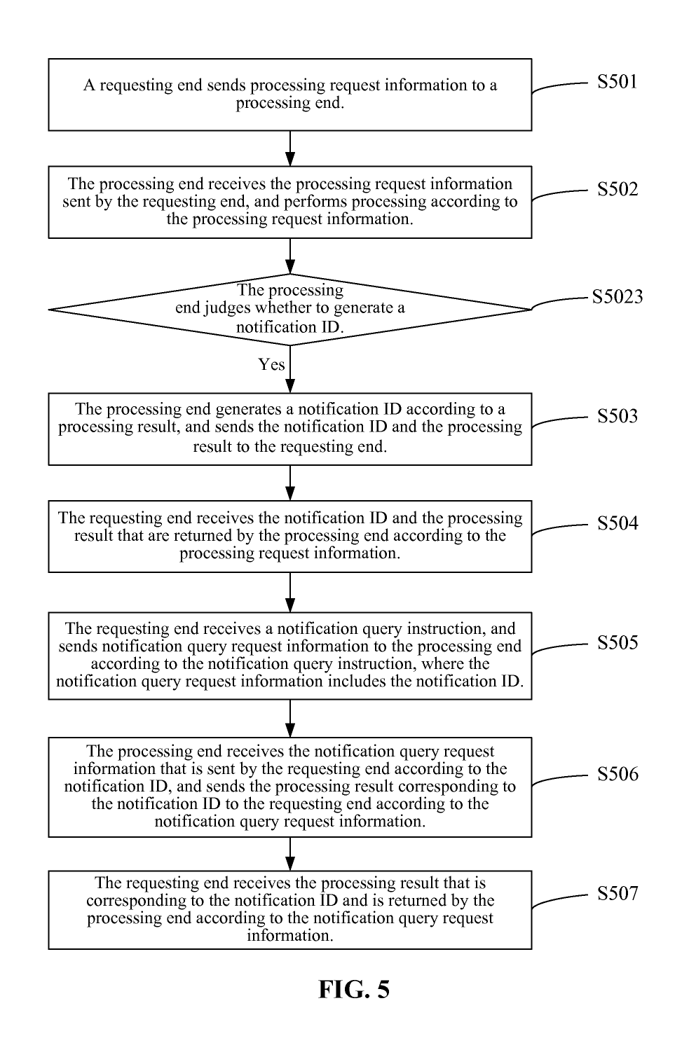

FIG. 5 is a schematic flow chart of Embodiment 4 of an online payment interactive processing method of the present invention. In Embodiment 4, an interaction process between a requesting end and a processing end is taken as an example for illustration, in which after receiving processing request information, the processing end may return a notification ID and a processing result to the requesting end.

As shown in FIG. 5, the online payment interactive processing method in Embodiment 4 includes the following steps.

Step S501: A requesting end sends processing request information to a processing end.

Step S502: The processing end receives the processing request information sent by the requesting end, and performs processing according to the processing request information.

Step S503: The processing end generates a notification ID according to a processing result, and sends the notification ID and the processing result to the requesting end.

Step S504: The requesting end receives the notification ID and the processing result that are returned by the processing end according to the processing request information.

Step S505: The requesting end receives a notification query instruction, and sends notification query request information to the processing end according to the notification query instruction, where the notification query request information includes the notification ID.

Step S506: The processing end receives the notification query request information that is sent by the requesting end according to the notification ID, and sends the processing result corresponding to the notification ID to the requesting end according to the notification query request information.

Step S507: The requesting end receives the processing result that is corresponding to the notification ID and is returned by the processing end according to the notification query request information.

Based on the solution in this embodiment, the processing end may send the notification ID and the corresponding processing result to the requesting end, and the requesting end judges whether the processing result needs to be re-queried for according to the notification ID, so as to ensure the security of the processing result.

It is taken as an example that the requesting end is a merchant website and the processing end is a payment platform, and based on the online payment interactive processing method in Embodiment 4 and with reference to the schematic diagram of the paying process in FIG. 4, a specific paying process may be described as follows.

After a user completes related order information and determines to pay for an order, the merchant website initiates a payment request to the corresponding payment platform website, that is, sends the processing request information to the payment platform website.

After receiving the payment request sent by the merchant website, the payment platform website completes payment of the order, and the payment of the order may be implemented in any possible manner. After the payment is completed, the payment platform website generates a notification ID of the order, to identify the order and the payment status related to the order, and after generating the notification ID, the payment platform website sends a processing result and the notification ID to the merchant website.

After receiving the processing result and the notification ID returned by the payment platform website, the merchant website judges whether a corresponding processing result needs to be re-queried for based on the notification ID from the payment platform website, so as to confirm or verify the processing result. A specific judging mechanism may be set according to application requirements. For example, it may be set that a query needs to be made when a commodity corresponding to the order is a virtual commodity, or a query needs to be made when a commodity corresponding to the order is a physical commodity, or a query needs to be made when the transaction amount of the order is greater than a threshold, or a query needs to be made in any condition, including specific set condition not described herein.

When a query needs to be made to the payment platform website, the merchant website sends notification query request information to the payment platform website according to the notification ID, where the notification query request information includes the notification ID.

After receiving the notification query request information sent by the merchant website, the payment platform website queries for a corresponding processing result according to the notification ID in the notification query request information. The processing result may include order information and processing result information related to the order. Definitely, the processing result may also be configured according to actual requirements. For example, the processing result may only include an order number, information about whether the payment is successful, and the like.

After receiving the processing result returned by the merchant website, the merchant website updates state of the order according to the processing result, and accordingly completes subsequent actions, such as a prompt of delivery of a virtual commodity or a physical commodity.

In the description of Embodiment 4 of the online payment interactive processing method in the present invention, it is taken as an example that the processing end sends the processing result and the notification ID to the requesting end, and the requesting end judges whether the processing result needs to be queried for according to the notification ID from the processing end. In another implementation manner, it is also applicable that the processing end judges whether to generate a notification ID and send the notification ID to the requesting end, and when determining to generate a notification ID, the processing end generates a corresponding notification ID and sends the notification ID and the processing result to the requesting end. That is, the following step may also be performed between Step S502 and Step S503.

S5023: The processing end judges whether to generate a notification ID, and if yes, proceed to Step S503.

That is to say, the processing end judges whether to generate a notification ID. When it is determined that a notification ID needs to be generated, the processing end performs subsequent processes such as generating the notification ID; and when it is determined that a notification ID does not need to be generated, the processing end may directly send the processing result to the requesting end.

The processing end may judge whether to generate a notification ID in various possible manners, for example, according to the type of the processing request information, the type and performance of the requesting end, and the like. It may even be set that a notification ID needs to be generated for any processing request information, and a specific manner of judging whether a notification ID needs to be generated is not described herein.

Other technical features in Embodiment 4 may be the same as those in Embodiment 3, which are not described herein again.

In the description of the online payment interactive processing method in the present invention, for better understanding, it is taken as an example for illustration that the requesting end is a merchant website and the processing end is a payment platform. It may be predicted that the method of the present invention may be applied to any field that requires assisted processing of a processing end which performs data transmission with another end and requires processing through system interaction. Therefore, the example made for the merchant website and the payment platform website does not limit the solution of the present invention, and based on the spirit of the solution of the present invention, the solution of the present invention may be applied to any field that requires processing through system interaction.

According to the online payment interactive processing method of the present invention, the present invention also provides an interactive processing system.

The interactive processing system of the present invention may only include a requesting end or a processing end, and may also include both a requesting end and a processing end.

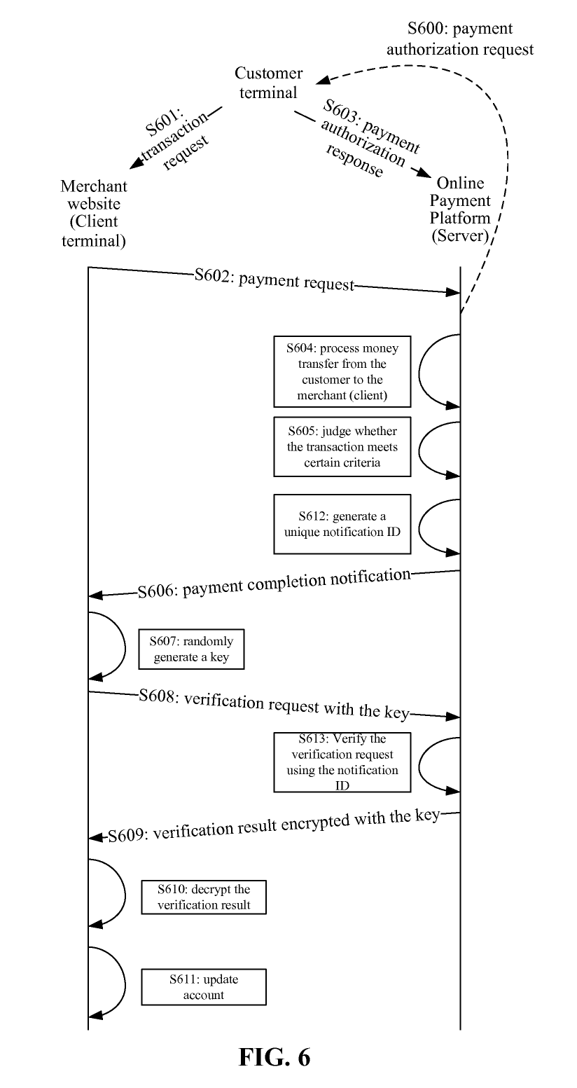

FIG. 6 is a flowchart of still another online payment online payment interactive processing method provided by an embodiment of the present invention.

The online payment process begins with a customer sending a transaction request to a merchant (step S601). The customer may be viewing a website of merchant and finds some goods that are desirable. The customer then operates on his/her computer to send a transaction request to the computer that is interacting with the merchant website.

When receiving a transaction request from a customer terminal, a computer of the merchant which is a client terminal of the online platform sends an online payment request to a server (step S602). The computer could be the one that delivers the content of the website, or could interact with the computer that delivers the content of the website. After the online payment platform responds to the payment request, the customer is directed to an online payment interface that is supported by an online payment platform. As shown in FIG. 6, the online payment platform may send a payment authorization request to the customer terminal (S600). The interface can either be displayed as part of the merchant website or an independent website. The online payment platform is a system that can transfer money from one account to another account. The online payment platform is supported by one or more server computers.

Through that interface, the customer authorizes the platform to transfer a certain amount of money from his/her account to the online payment platform. The customer can operate on his/her customer terminal to send a payment authorization response to the server of the online payment platform (step S603). The payment authorization response includes certain information, e.g., a user name, password, security questions, to verify the identifier of the customer. In some embodiments, the user of the customer terminal provides a unique identifier (e.g., an alphanumerical string) through the input/output device of the customer terminal. For example, the payment authorization request may include a randomly generated number to be displayed on the customer terminal. The user of the customer terminal repeats the randomly generated number or a variation thereof, which is then sent back to the online payment platform as part of the payment authorization response. The interface can be displayed either before or after a computer of the merchant sending the online payment request. The payment authorization response may also include information regarding the amount of the money that is intended to be transferred and, sometimes, the purpose of the payment. In some embodiments, the payment authorization response is sent through the computer of the merchant.

In step S604, based on the payment request from the client terminal and the payment authorization response from the customer terminal, the server would process the money transfer from the customer to the client. In some embodiments, the server is connected with a computer of a bank or a money management entity, and instructs the bank or the money management entity to transfer the money.

Step S605 exists in some embodiments of this invention. In step S605, the server will judge whether the transaction between the buyer/customer and the merchant/client meets certain pre-set criteria. In some embodiments, the merchant wants a safer process of payment for some of the transactions and a simpler process of payment for others. The merchant can set predetermined criteria based on the risk of the transactions. The predetermined criteria can include, the type of goods involved in the transaction, the total amount of payment, the type of the customer, the past history of a customer, a mixture of multiple factors, etc. For example, virtual goods can be perceived to have higher risk of fraud than material one. A long-term customer can be perceived to be safer than a first-time customer. In some embodiments, the criteria are saved in the server so that the server can make judgment based on those criteria. In some embodiments, the merchant computer (client terminal) can makes determination on the desirability of the safer process of payment. The client terminal can send the determination to the server and the criteria and judgment of the server are entirely based on the determination of the client terminal.

If the server decides to follow a simple process of payment (the transaction meets the predetermined criteria), it sends a payment completion result to the client terminal. The payment completion result may include the information that the client terminal needs to update the account. For example, the payment completion result may include the categories and quantity of goods sold, the amount of the payment, the identifier of the buyer, etc.

If the server decides to follow a safer process of payment (the transaction does not meet the predetermined criteria), it sends a payment completion notification to the client terminal (step S606). In some embodiments, the payment completion notification includes a unique notification identifier generated by the server (S612), which is associated with the payment request from the client terminal. For example, the unique notification identifier may be derived at least in part from the unique identifier provided by the customer in the payment authorization response. The payment completion notification cannot be used to update the account. In some embodiments, the server only sends payment completion result. It is the client terminal that decides whether this transaction enters into the simple payment process or safe payment process.

In step S607, the client terminal then randomly generates a key. Common random key generation algorithms can be used. The randomly generated key is then saved in memory until the account is updated. Depending on the desired safety level, step S607 can be omitted from the process of payment in some embodiments.

In step S608, the client terminal sends a payment verification request to the server, along with the key. The information of the payment verification request is partly from the payment completion notification (e.g., the server-generated notification ID). The payment verification request contains enough information for the server to identify which payment the payment verification request is related to. In some embodiments the payment verification request is secured in a way that is different from the payment request and payment completion notification. For example, the key used to encrypt the payment request can be different from the one used to encrypt the verification request.

After the server receives the verification request, the server verifies whether the payment related with the payment verification request happens or whether some of the information of the payment verification request (e.g., the notification ID) is correct (S613). If the server confirms the existence of the payment or the accuracy of the information of the verification request, it will prepare a payment verification result.

In step S609, the server encrypts a payment verification result with the key and sends it to the client terminal. In step S610, the client terminal decrypts the payment verification result with the key.

One advantage of the randomly generated key is that it cannot be leaked before the transaction. A potential risk in business transactions is that someone may produce a fake payment completion notification. The client terminal or the merchant may instruct to deliver goods based on the false belief that the payment has been made. A randomly generated key can effectively prevent receiving such fake payment verification result.

In step S611, the client terminal updates the account based on the information from the decrypted payment verification result. The merchant can prepare to deliver the goods based on the updated account.

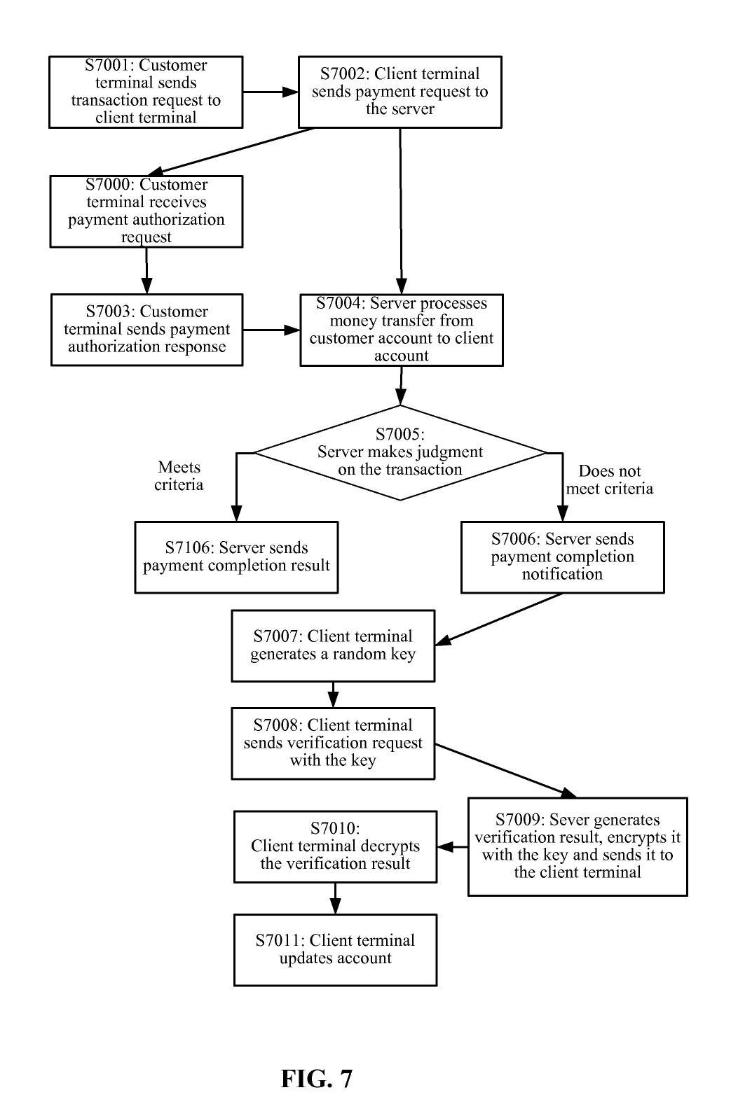

FIG. 7 is a flowchart of still another online payment method provided by an embodiment of the present invention.

The online payment process begins with a customer sending a transaction request to a merchant (step S7001). The customer may be viewing a website of merchant and finds some goods that are desirable. The customer then operates on his/her computer to send a transaction request to the computer that is interacting with the merchant website.

When receiving a transaction request from a customer terminal, a computer of the merchant which is a client terminal of the online platform sends an online payment request to a server (step S7002). The computer could be the one that delivers the content of the website, or could interact with the computer that delivers the content of the website. After the online platform responds to the payment request, the customer is directed to an online payment interface that is supported by an online payment platform. For example, the customer terminal may receive a payment authorization request (S7000), which includes information associated with the transaction such as the name, price, and amount of the goods. The interface can be displayed either as part of the merchant website or as an independent website. The online payment platform is a system that can transfer money from one account to another account. The online payment platform is supported by one or more server computers.

Through that interface, the customer authorizes the platform to transfer a certain amount of money from his/her account to the online payment platform. The customer can operate on his/her customer terminal to send a payment authorization response to the server of the online payment platform (step S7003). The payment authorization response includes certain information, e.g., a user name, password, security questions, to verify the identifier of the customer. In some embodiments, the payment authorization response may include a unique identifier chosen by the user of the customer terminal, which may be in the form of an electronic signature. The interface can be displayed either before or after a computer of the merchant sending the online payment request. The payment authorization response may also include information regarding the amount of the money that is intended to be transferred and, some time, the purpose of the payment. In some embodiments, the payment authorization response is sent through the computer of the merchant.

In step S7004, based on the payment request from the client terminal and the payment authorization response from the customer terminal, the server would process the money transfer from the customer to the client. In some embodiments, the server is connected with a computer of a bank or a money management entity, and instructs the bank or the money management entity to transfer the money.

Step S7005 exists in some embodiments of this invention. In step S7005, the server will judge whether the transaction between the buyer/customer and the merchant/client meets certain pre-set criteria. In some embodiments, the merchant wants a safer process of payment for some of the transactions and a simpler process of payment for others. The merchant can set predetermined criteria based on the risk of the transactions. The predetermined criteria can include, the type of goods involved, the total amount of the transaction, past history of a customer, a mixture of multiple factors, etc. For example, virtual goods can be perceived to have higher risk of fraud than material one. A long-term customer can be perceived to be safer than a first-time customer. In some embodiments, the criteria are saved in the server so that the server can make judgment based on those criteria. In some embodiments, the merchant computer (client terminal) can makes determination on the desirability of the safer process of payment. The client terminal can send the determination to the server and the criteria and judgment of the server are entirely based on the determination of the client terminal.

If the server decides to follow a simple process of payment (the transaction meets the predetermined criteria), it sends a payment completion result to the client terminal (step S7106). The payment completion result may include the information that the client terminal needs to update the account.

If the server decides to follow a safer process of payment (the transaction does not meet the predetermined criteria), it sends a payment completion notification to the client terminal (step S7006). In some embodiments, the payment completion notification includes a unique notification identifier associated with the payment request. The unique notification identifier may be generated at least in part based on information in the payment authorization response provided by the user of the customer terminal. The payment completion notification cannot be used to update the account. In some embodiments, the server only sends payment completion result. It is the client terminal that decides whether enters into simple payment process or safe payment process.

In step S7007, the client terminal then randomly generates a key. Common random key generation algorithms can be used. The randomly generated key is then saved in memory until the account is updated. Depending on the desired safety level, step S7007 can be omitted from the process of payment in some embodiments.

In step S7008, the client terminal sends a payment verification request to the server, along with the key. The information of the payment verification request is partly from the payment completion notification. The payment verification request contains enough information for the server to identify which payment the payment verification request is related to. In some embodiments the payment verification request is secured in a way that is different from the payment request and payment completion notification. For example, the key used to encrypt the payment request can be different from the one used to encrypt the verification request.

After the server receives the verification request, the server verifies, e.g., using the server-generated notification identifier, whether the payment related with the payment verification request happens or whether some of the information of the payment verification request is correct. If the server confirms the existence of the payment or the accuracy of the information of the verification request, it will prepare a payment verification result.

In step S7009, the server encrypts a payment verification result with the key and sends it to the client terminal. In step S7010, the client terminal decrypts the payment verification result with the key. In some embodiments, the payment verification result includes the categories and quantity of goods sold, the amount of the payment, the identifier of the buyer, etc. Such information facilitates the client terminal to make sure the accuracy of transaction record.

In step S7011, the client terminal updates the account based on the information from the decrypted payment verification result. The merchant can prepare to deliver the goods based on the updated account.

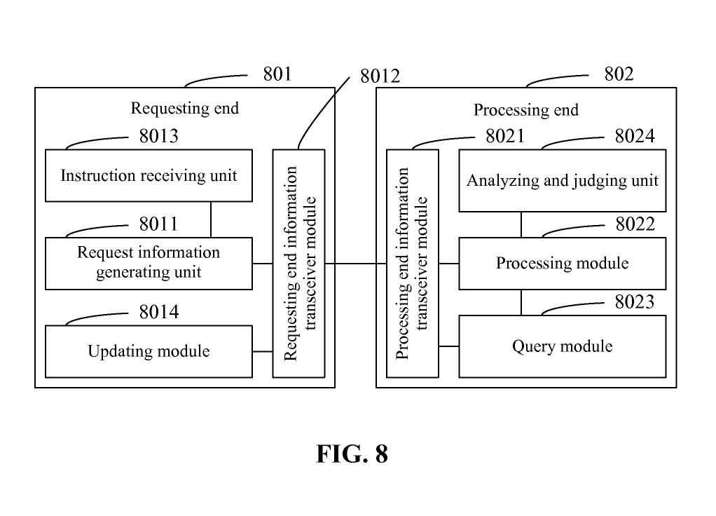

FIG. 8 is a schematic structural diagram of an embodiment of an interactive processing system of the present invention. For ease of illustration, it is taken as an example in FIG. 8 that a requesting end and a processing end are both included.

As shown in FIG. 8, the interactive processing system in the example includes a requesting end 801 and a processing end 802, where:
the requesting end 801 is configured to send processing request information to the processing end 802, receive a notification ID that is returned by the processing end 802 according to the processing request information, send notification query request information to the processing end 802 according to the notification ID, and receive a processing result that is corresponding to the notification ID and is returned by the processing end 802 according to the notification query request information; and
the processing end 802 is configured to receive processing request information sent by the requesting end 801, perform processing according to the processing request information, generate a notification ID according to a processing result, send the notification ID to the requesting end 801, receive notification query request information that is sent by the requesting end 801 according to the notification ID, and send the processing result corresponding to the notification ID to the requesting end 801 according to the notification query request information.

In a specific example, the requesting end 801 may specifically include:
a request information generating unit 8011, configured to generate the processing request information and the notification query request information; and
a requesting end information transceiver module 8012, configured to send the processing request information and the notification query request information to the processing end 802, and receive the notification ID returned by the processing end 802 and the processing result corresponding to the notification ID.

The processing end 802 may specifically include:
a processing end information transceiver module 8021, configured to receive the processing request information and the notification query request information sent by the requesting end 801, and send to the requesting end 801 the notification ID obtained by a processing module 8022 and the processing result obtained through query by a query module 8023;
the processing module 8022, configured to perform processing according to the processing request information to obtain the processing result, and generate the notification ID according to the processing result; and
the query module 8023, configured to obtain the processing result corresponding to the notification ID according to the notification query request information.

In another specific example, the processing end information transceiver module 8021 is also configured to send the processing result obtained by the processing module 8022 to the requesting end 801 while sending the notification ID to the requesting end 801.

Correspondingly, the requesting end information transceiver module 8012 is also configured to receive the processing result that is returned by the processing end 802 according to the processing request information, that is, the processing result that is obtained by the processing module 8022 and is sent by the processing end information transceiver module 8021. In some embodiments, information transceiver module 8012 is also responsible for decrypting the payment verification result.

In another specific example, the requesting end 801 may also include an instruction receiving unit 8013, configured to receive a notification query instruction.

Correspondingly, the request information generating unit 8011 is configured to generate the notification query request information according to the notification query instruction received by the instruction receiving unit 8013. Request information generating unit is further configured to generate a random key that is to be sent with the payment verification request as described in FIGS. 6 and 7.

In another specific example, the processing end may also include an analyzing and judging unit 8024, configured to judge whether a notification ID needs to be generated. The analyzing and judging unit 8024 is further configured to judge whether a transaction meets certain criteria.

The processing module 8022 generates the notification ID according to the processing result, when the analyzing and judging unit 8024 determines that a notification ID needs to be generated. The processing module 8022 is configured to generate both the payment completion result and the payment completion notification.

The query module 8023 is configured to obtain the processing result (either payment completion result or payment verification result). The query module is configured to acquire transaction related information, such as the categories and quantity of goods sold, the amount of the payment, the identifier of the buyer. The query module may acquire transaction related information based on the information in the payment verification result and send it to the transceiver module.

In a specific application, the requesting end 801 may be a merchant website, and correspondingly, the processing end 802 may be a payment platform website or a bank website.

For the merchant website, the payment of an order requires to be processed by the payment platform website or the bank website. Therefore, after receiving a processing result corresponding to the notification ID and returned by the payment platform website or the bank website, the merchant website may also update state of the order according to the processing result. In this case, the requesting end 801 may also include an updating module 8014, configured to update state of the order according to the processing result that is corresponding to the notification ID and returned by the payment platform website.

Other technical features of the interactive processing system of the present invention may be the same as those of the online payment interactive processing method of the present invention, which are not described herein again.

The embodiments described above only represent several implementation manners of the present invention, and the descriptions thereof are specific and detailed, but should not be understood as a limitation to the scope of the present invention. It should be pointed out that persons of ordinary skill in the art can make modifications and improvements without departing from the spirit of the present invention, and these modifications and improvements all fall within the protection scope of the present invention. Therefore, the protection scope of the present invention shall be subject to the appended claims.

While particular embodiments are described above, such description is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

Although the terms first, second, etc. may be used herein to describe various elements, these elements should not be limited by these terms. These terms are only used to distinguish one element from another. For example, first ranking criteria could be termed second ranking criteria, and, similarly, second ranking criteria could be termed first ranking criteria, without departing from the scope of the present invention. First ranking criteria and second ranking criteria are both ranking criteria, but they are not the same ranking criteria.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain principles of the invention and its practical applications, to thereby enable others skilled in the art to best utilize the invention and various implementations with various modifications as are suited to the particular use contemplated. Implementations include alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the implementations.

What is claimed is:

1. A method of online payment performed at a client terminal having a processor and memory for storing one or more programs to be executed by the processor, the method comprising:
sending a payment request associated with a user account to a payment processing server;
receiving a payment completion notification from the payment processing server, the payment completion notification including a unique notification identifier associated with the payment request;
sending a payment verification request based on the unique notification identifier to the payment processing server;
receiving a payment verification result from the payment processing server; and
updating the user account based on information in the payment verification result.

2. The method of claim 1, wherein the payment verification result is configured to be decrypted by the client terminal using a key that is pre-stored in the client terminal.

3. The method of claim 2, wherein the payment verification result is encrypted by the payment processing server using the key that is pre-stored in the payment processing server.

4. The method of claim 1, further comprising: before sending the payment request to the payment processing server, receiving a transaction request from a terminal associated with the user account, wherein the payment request contains at least part of information in the transaction request.

5. The method of claim 1, wherein the payment verification result includes information related to the categories and quantity of goods of a transaction.

6. The method of claim 1, wherein the client terminal is associated with a merchant website.

7. The method of claim 1, wherein the payment processing server is configured to interact with a payment platform website or a bank website upon receipt of the payment request.

8. An method of online payment performed at a payment processing server having a processor and memory for storing one or more programs to be executed by the processor, the method comprising:
receiving a payment request from a client terminal, wherein the payment request is generated in response to a transaction request from a terminal associated with a user account;
generating and sending a payment completion notification to the client terminal, the payment completion notification including a unique notification identifier associated with the payment request;
receiving a payment verification request from the client terminal;
verifying the payment verification request using the unique notification identifier; and
generating and sending a payment verification result to the client terminal.

9. The method of claim 8, wherein the payment verification result contains information related to the categories and quantity of goods of a transaction.

10. The method of claim 8, wherein the client terminal is associated with a merchant website.

11. The method of claim 8, wherein the payment processing server is configured to interact with a payment platform website or a bank website upon receipt of the payment request.

12. The method of claim 8, further comprising: before generating and sending the payment completion notification to the client terminal, sending a payment authorization request to the terminal associated with the user account and receiving and processing a payment authorization response from the terminal associated with the user account.

13. The method of claim 12, wherein the payment authorization response includes a unique identifier provided by a user of the terminal associated with the user account and the unique identifier is used for generating the unique notification identifier.

14. A server of processing online payment, comprising:
one or more processors;
memory; and
one or more programs stored in the memory and to be executed by the processor, the one or more programs including instructions for:
receiving a payment request from a client terminal, wherein the payment request is generated in response to a transaction request from a terminal associated with a user account;
generating and sending a payment completion notification to the client terminal, the payment completion notification including a unique notification identifier associated with the payment request;
receiving a payment verification request from the client terminal;
verifying the payment verification request using the unique notification identifier; and
generating and sending a payment verification result to the client terminal.

15. The server of claim 14, wherein the one or more programs further include instructions for:
before generating and sending the payment completion notification to the client terminal, sending a payment authorization request to the terminal associated with the user account and receiving and processing a payment authorization response from the terminal associated with the user account.

16. The server of claim 15, wherein the payment authorization response includes a unique identifier provided by a user of the terminal associated with the user account and the unique identifier is used for generating the unique notification identifier.

17. The server of claim 14, wherein the client terminal is associated with a merchant website.

18. The server of claim 14, wherein the one or more programs further include instructions for:
before generating and sending the payment completion notification to the client terminal, judging whether a transaction associated with the payment request meets certain predetermined criteria.

19. The server of claim 18, wherein the payment verification result contains information related to the categories and quantity of goods of the transaction.

20. The server of claim 14, wherein the one or more programs further include instructions for interacting with a payment platform website or a bank website upon receipt of the payment request.
